(19) United States
(12) Patent Application Publication
(10) Pub. No.: US 2017/0208221 A1
(43) Pub. Date: Jul. 20, 2017

(54) MULTIMEDIA PLAYING DEVICE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Yanqi Huang, Tianjin (CN)

(21) Appl. No.: 15/240,662

(22) Filed: Aug. 18, 2016

Related U.S. Application Data
(63) Continuation of application No. PCT/CN2016/088963, filed on Jul. 6, 2016.

(30) Foreign Application Priority Data
Jan. 20, 2016 (CN) 201610036657.2

(51) Int. Cl. H04N 5/14

(52) U.S. Cl. CPC H04N 5/14

(57) ABSTRACT

An embodiment of the disclosure provides a multimedia playing device so as to reduce the waste of resources as a result of upgrading the multimedia playing device, and to improve a sound effect thereof. The multimedia playing device includes an acoustic sub-system and a display sub-system, wherein the acoustic sub-system is configured to obtain image data in a preset format according to an one or more external devices' signals, and to transmit the image data in the preset format to the display sub-system; and to play an audio according to the one or more external devices' signals; and the display sub-system is configured to display an image according to the image data in the preset format transmitted by the acoustic sub-system.

### CROSS REFERENCE TO RELATED APPLICATIONS

This application is a continuation of International Application No. PCT/CN2016/088963, filed on Jul. 6, 2016, which is based upon and claims priority to Chinese Patent Application No. 201610036657.2, filed on Jan. 20, 2016, the entire contents of which are incorporated herein by reference.

### TECHNICAL FIELD

On one aspect, the present disclosure relates to the field of multimedia playing, and particularly to a multimedia playing device.

### BACKGROUND

The components of some existing multimedia playing devices, e.g., a smart TV set, have been integrated together, and the inventors of the disclosure have identified a number of problems in such an integrated multimedia playing device, for example:

None of the respective components of the multimedia playing device can be upgraded separately, and if one of the components in the multimedia playing device can not meet the requirement of its user, for example, function of a controller of the multimedia playing device can not meet the requirement of the user, then the entire multimedia playing device may be replaced, thus resulting in a serious waste of resources.

Moreover there is also such a growing demand of the user for the appearance of the multimedia playing device that the appearance thereof is typically expected to be more light-weighted and thinner as preferred, so the size of a speaker in the integrated multimedia playing device is typically so small that there is a poor sound effect of the multimedia playing device.

### SUMMARY

The disclosure provides a multimedia playing device to reduce wasting of resources as a result of upgrading the multimedia playing device, and to improve a sound effect thereof.

An embodiment of the disclosure provides a multimedia playing device including an acoustic sub-system and a display sub-system connected with the acoustic sub-system, wherein:

the acoustic sub-system is configured to obtain some image data in a preset format according to one or more external devices' signals, and to transmit the image data in the preset format to the display sub-system; and to play an audio according to the one or more external devices' signals; and

the display sub-system is configured to display an image according to the image data in the preset format transmitted by the acoustic sub-system.

The multimedia playing device according to the embodiments of the disclosure includes the two components, i.e., the acoustic sub-system and the display sub-system, both of which can be upgraded separately, thus reducing the waste of resources as compared with the prior art; and the appearances of the two components can be designed separately so that the display sub-system can be made light-weighted and thin for a pleasing appearance thereof without compromising the size of the speaker in the acoustic sub-system so as to ensure the sound effect of the multimedia playing device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a first schematic diagram of a multimedia playing device according to an embodiment of the disclosure;

FIG. 2 is a second schematic diagram of a multimedia playing device according to an embodiment of the disclosure;

FIG. 3 is a third schematic diagram of a multimedia playing device according to an embodiment of the disclosure;

FIG. 4 is a fourth schematic diagram of a multimedia playing device according to an embodiment of the disclosure;

FIG. 5 is a fifth schematic diagram of a multimedia playing device according to an embodiment of the disclosure;

FIG. 6 is a sixth schematic diagram of a multimedia playing device according to an embodiment of the disclosure;

FIG. 7 is a schematic external structure diagram of an acoustic sub-system in a multimedia playing device according to an embodiment of the disclosure;

FIG. 8 is a seventh schematic diagram of a multimedia playing device according to an embodiment of the disclosure;

FIG. 9 is an eighth schematic diagram of a multimedia playing device according to an embodiment of the disclosure;

FIG. 10 is a schematic external structure diagram of a display sub-system in a multimedia playing device according to an embodiment of the disclosure; and

FIG. 11 is a schematic micro structure diagram of a display sub-system in a multimedia playing device according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

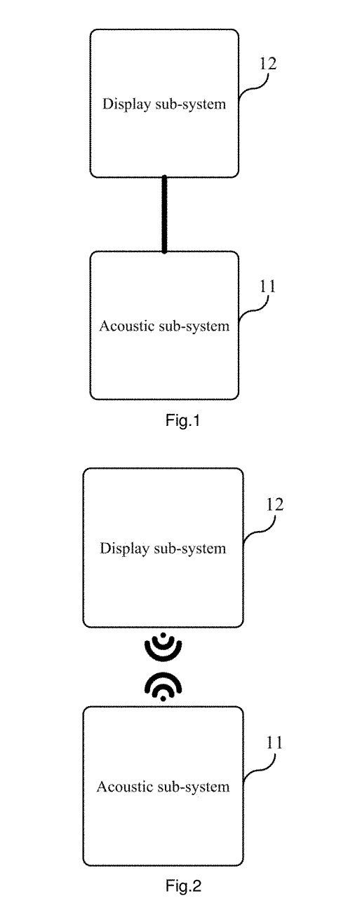

As illustrated in FIG. 1 and FIG. 2, a multimedia playing device according to an embodiment of the disclosure provides two components, i.e., an acoustic sub-system 11 and a display sub-system 12 connected with the acoustic sub-system 11, where:

The acoustic sub-system 11 is configured to obtain some image data in a preset format according to one or more external devices' signals, and to transmit the image data in the preset format to the display sub-system 12; and to play an audio according to the one or more external devices' signals; and

The display sub-system 12 is configured to display an image according to the image data in the preset format transmitted by the acoustic sub-system.

Furthermore the acoustic sub-system 11 can be further configured to transmit a control command on the display sub-system 12 to the display sub-system 12.

The embodiment of the disclosure will not be limited to any particular mode in which the acoustic sub-system 11 and the display sub-system 12 in the multimedia playing device according to the embodiment of the disclosure are connected.

In a particular embodiment of the disclosure, as illustrated in FIG. 1, the acoustic sub-system 11 and the display sub-system 12 can be connected via a control bus to transmit the image data in the preset format, and the control command.

Particularly the image data can be transmitted via the control bus in the High Definition Multimedia Interface (HDMI) technical specification and the Universal Serial Bus (USB) standard; and a Three Dimensional (3D) control command, an Inter-integrated Circuit (IIC) bus control command, etc., can be transmitted via the control bus.

In another particular embodiment of the disclosure, as illustrated in FIG. 2, the acoustic sub-system 11 and the display sub-system 12 can alternatively be connected wirelessly to transmit the image data in the preset format, and the control command.

At this time the acoustic sub-system 11 and the display sub-system 12 communicate through wireless transmission so that they can be avoided from being fettered by cables, and provided with a more pleasing appearance. The embodiment of the disclosure will not be limited to any particular mode in which the acoustic sub-system 11 and the display sub-system 12 are connected wirelessly, but they can be connected wirelessly in any one of the modes in the prior art so that a transmission module of the wireless connection can be integrated in the acoustic sub-system 11 or the display sub-system 12, or can be arranged outside of the acoustic sub-system 11 or the display sub-system 12, although a detailed description thereof will be omitted here.

The embodiment of the disclosure will not be limited to any particular mode in which the acoustic sub-system 11 and the display sub-system 12 in the multimedia playing device according to the embodiment of the disclosure are powered.

In a particular embodiment of the disclosure, mains power can be input respectively to the acoustic sub-system 11 and the display sub-system 12 to power them separately.

In another particular embodiment of the disclosure, mains power can be input only to the acoustic sub-system 11, and the display sub-system 12 can be powered by the acoustic sub-system 11. If the acoustic sub-system 11 and the display sub-system 12 are connected via a control bus, then the acoustic sub-system 11 can power the display sub-system 12 via the control bus.

In another particular embodiment of the disclosure, mains power can be input only to the display sub-system 12, and the acoustic sub-system 11 can be powered by the display sub-system 12. If the acoustic sub-system 11 and the display sub-system 12 are connected via a control bus, then the display sub-system 12 can power the acoustic sub-system 11 via the control bus.

The multimedia playing device according to the embodiment of the disclosure can particularly be but will not be limited to a smart TV set, or can be a Digital Versatile Disc (DVD) player, or another audio data or/and video device.

If the multimedia playing device according to the embodiment of the disclosure is a smart TV set, the one or more external devices' signals input to the multimedia device may include audio data or/and video data, or may include a digital TV signal; and if the multimedia playing device according to the embodiment of the disclosure is a DVD player, then the one or more external devices' signals input to the multimedia device may generally include audio data or/and video data.

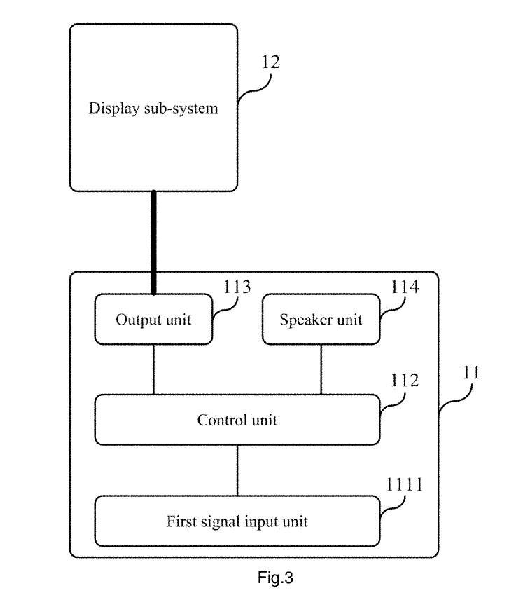

If the one or more external devices' signals include audio data or/and video data, then the acoustic sub-system 11 as illustrated in FIG. 3 can particularly include a first signal input unit 1111, a control unit 112, an output unit 113, and a speaker unit 114, where:

The first signal input unit 1111 is configured to receive the audio data or/and video data; and particularly the first signal input unit 1111 can include at least one of an optic fiber input interface, a Secure Digital (SD) memory card interface, a network interface, and a USB interface, and receive the audio data or/and video data via the interface;

The control unit 112 is configured to convert the video data into the image data in the preset format; and to process the audio data so that processed audio data can be obtained by the control unit 112;

The output unit 113 is configured to transmit the image data in the preset format; and

The speaker unit 114 is configured to play audio according to the processed audio data.

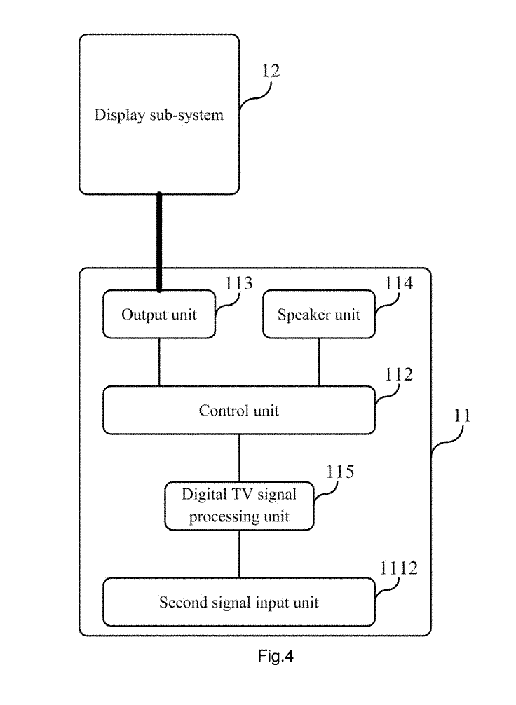

If the one or more external devices' signals include a digital TV signal, then the acoustic sub-system 11 as illustrated in FIG. 4 can particularly include a second signal input unit 1112, a digital TV signal processing unit 115, a control unit 112, an output unit 113, and a speaker unit 114, where:

The second signal input unit 1112 is configured to receive the digital TV signal; and particularly the second signal input unit 1112 can include a digital TV interface, and receive the digital TV signal via the digital TV interface;

The digital TV signal processing unit 115 is configured to convert the digital TV signal into audio data or/and video data; and particularly the digital TV signal processing unit 115 is configured to firstly demodulate the digital TV signal into a digital video transport stream, and then recover the digital video transport stream into original digitalized audio data or/and video data;

The control unit 112 is configured to convert the video data into the image data in the preset format; and to process the audio data so that processed audio data can be obtained by the control unit 112;

The output unit 113 is configured to transmit the image data in the preset format; and

The speaker unit 114 is configured to play the processed audio data.

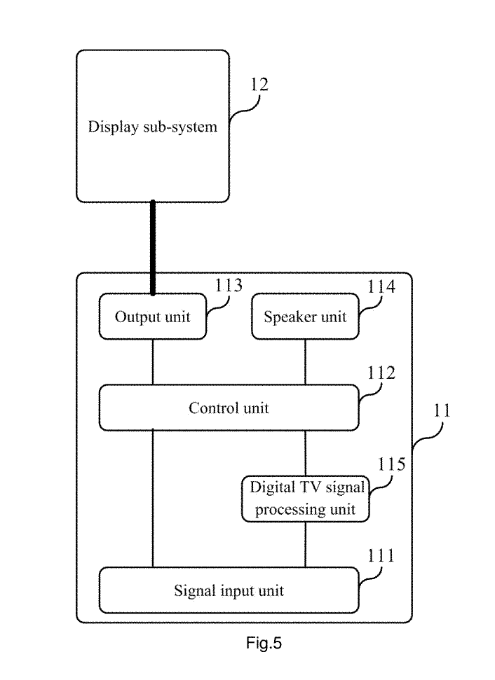

Apparently in the two particular embodiments illustrated in FIG. 3 and FIG. 4, the two control units 112 are the same control unit, the two output units 113 are the same output unit, and the two speaker units 114 are the same speaker unit; and the first signal input unit 1111 and the second signal input unit 1112 can alternatively be integrated in the same signal input unit 111, and at this time, the acoustic sub-system 11 in the multimedia playing device according to the embodiment of the disclosure is as illustrated in FIG. 5.

In FIG. 5, the signal input unit 111 can receive audio data or/and video data, or can receive a digital TV signal; and the control unit 112 can process the audio data or/and video data input by the signal input unit 111, or can process the audio data or/and video data input by the digital TV signal processing unit 115.

Preferably the acoustic sub-system 11 can further include a button input unit 116 connected with the control unit 112, and the user can input a control instruction on the multimedia playing device using a button which can particularly be a physical button or a touch button.

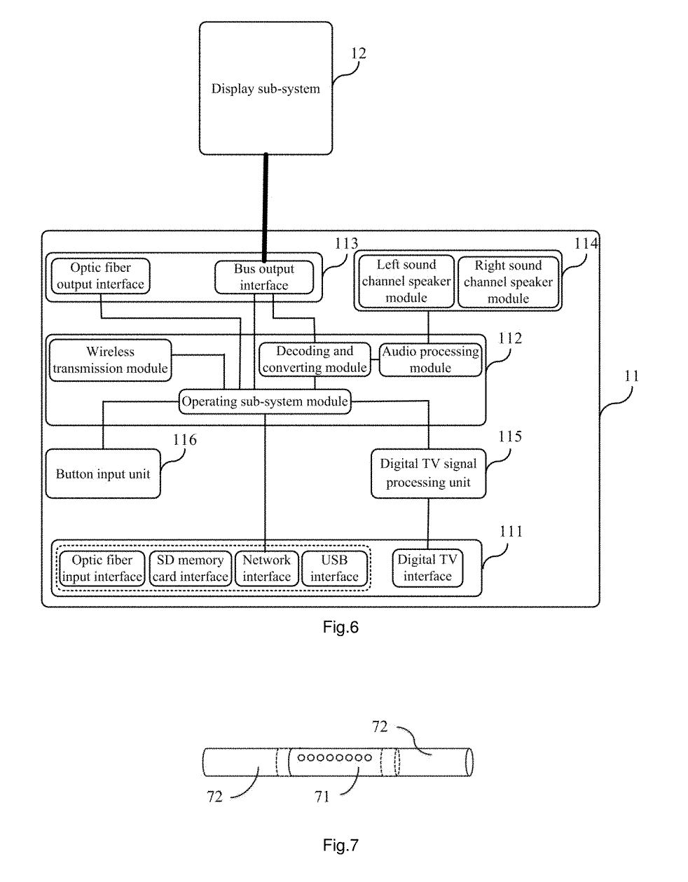

In a particular implementation, the signal input unit 111 in FIG. 5 can include an optic fiber input interface, an SD memory card interface, a network interface, a USB interface, and a digital TV interface as illustrated in FIG. 6.

In a particular implementation, the control unit 112 in FIG. 5 can include an operating sub-system module, a decoding and converting module, and an audio processing module as illustrated in FIG. 6, where:

The operating sub-system module is configured to run an intelligent operating sub-system, to receive the audio data or/and video data input by the signal input unit 111, the audio data or/and video data input by the digital TV signal processing unit 115, and the control instruction input by the button input unit 116, to output the audio data or/and video data to the decoding and converting module, and to output the control instruction to the output unit 113;

The decoding and converting module is configured to convert the video data into the image data in the preset format; and to output the image data to the output unit 113, and to output the audio data to the audio processing module; and

The audio processing module is configured to process the audio data so that processed audio data can be obtained by the audio processing module, and to output the processed audio data to the speaker unit 114.

Here the operating sub-system module runs the intelligent operating sub-system which can include a traditional TV chip or an OTT box chip, but also can be integrated with a high-performance chip of a mobile phone, a tablet PC, or the like, so that the chips can operate across the platforms to thereby improve the performance of the sub-system so as to bring a better experience of the user, where OTT stands for Over The Top, which refers to various application services accessible to the user over the Internet.

Preferably the control unit 112 can further include a wireless transmission module connected with the operating sub-system module for wireless communication with an external device. The embodiment of the disclosure will not be limited to any particular form of the wireless transmission module, but the wireless transmission module can be a WiFi module, a Bluetooth module, or a wireless transmission module in another form.

In a particular implementation, if the acoustic sub-system 11 and the display sub-system 12 are connected via a control bus, then the output unit 113 in FIG. 5 can include a bus output interface as illustrated in FIG. 6, via which the control instruction, and the image data in the preset format are transmitted.

Preferably the output unit 113 can further include an optic fiber interface via which the control unit 112 is connected with the external device.

In a particular implementation, the speaker unit 114 in FIG. 5 can include a left sound channel speaker module and a right sound channel speaker module as illustrated in FIG. 6.

In a real implementation, the external structure of the acoustic sub-system 11 can include a central cavity 71 and left/right cavities 72 as illustrated in FIG. 7. The signal input unit, the control unit, and the output unit can be arranged inside the central cavity 71, the button input unit can be arranged outside the central cavity 71, and the speaker unit can be arranged inside the left/right cavities 72.

In order to optimize thermal dissipation, an air duct an be arranged in areas of the left/right cavities 72 proximate to the central cavity 71 to dissipate heat through an airflow generated by the speaker unit in operation; and thermal dissipation holes can be opened on the backside and the bottom side of the central cavity 71 to assist in thermal dissipation.

For the sake of future upgrading and convenient repairing of the product, the control unit 112 can be connected with the other units in the acoustic sub-system 11 in plug-in type, and can be designed in structure so that the control unit can be plugged into and pulled out of the central cavity 71 easily.

It shall be noted that the particular implementations above of the acoustic sub-system 11 are merely exemplary, and in other particular embodiments of the disclosure, the acoustic sub-system 11 can alternatively be embodied otherwise, although a detailed description thereof will be omitted here.

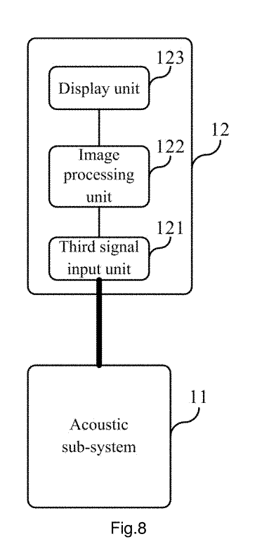

Furthermore the display sub-system 12 can particularly include a third signal input unit 121, an image processing unit 122, and a display unit 123 as illustrated in FIG. 8, where:

The third signal input unit 121 is configured to receive the image data in the preset format, where if the acoustic sub-system 11 and the display sub-system 12 are connected via a control bus, then the third signal input unit 121 can include a bus input interface, and receive the image data in the preset format via the bus input interface;

The image processing unit 122 is configured to process the image data in the preset format so that processed image data can be obtained by the image processing unit 122; and

The display unit 123 is configured to play the processed image data.

Preferably the third signal input unit 121 can be further configured to receive external image data; and particularly the third signal input unit 121 can include an HDMI interface, and receive the external image data via the HDMI interface; and

The image processing unit 122 is further configured to process the external image data so that processed external image data can be obtained by the image processing unit 122.

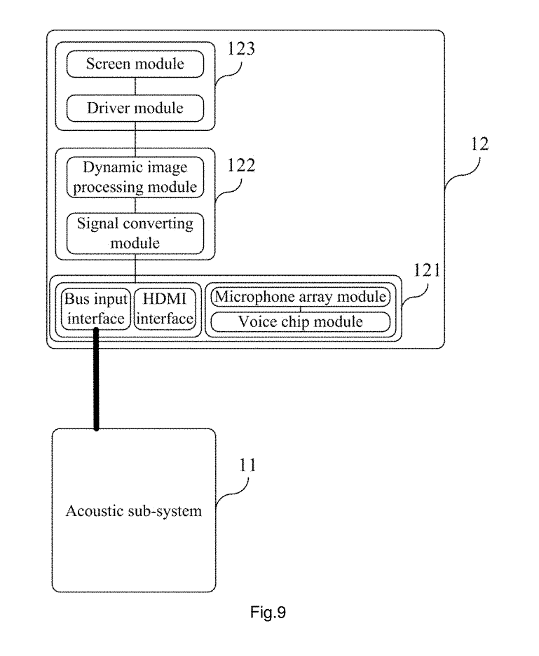

In a particular implementation, as illustrated in FIG. 9, the image processing unit 122 can particularly include a signal converting module and a dynamic image processing module; and the display unit 123 can particularly include a driver module and a screen module, where the screen module can be but will not be limited to a plasmas display screen, a light emitting diode display screen, or a liquid crystal display screen, and can be a flat screen or a curve screen.

Preferably the third signal input unit 121 can be further configured to receive external voice data; and at this time, the third signal input unit 121 can further include a voice processing unit configured to process the external voice data.

In a particular implementation, as illustrated in FIG. 9, the voice processing unit can particularly include a voice chip module and a microphone array module.

Preferably the third signal input unit 121 can further include a USB interface, etc.

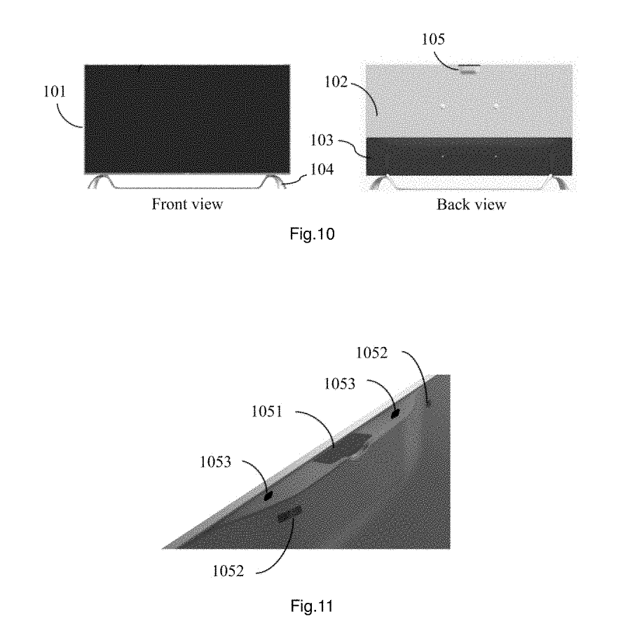

In a real implementation, the external structure of the display sub-system 12 can include a front frame 101, a large back plate 102, a small back housing 103, and a base element 104 as illustrated in FIG. 10, all of which can be made of metal, transparent plastic, transparent glass, toughened glass, or any one of other materials as appropriate.

An opening for the bus input interface in the third signal input unit 121 can be opened on the small back housing 103.

A micro structure 105 for being compatible with a USB module can be arranged above the large back plate 102, and as illustrated in FIG. 11, the micro structure 105 includes a USB opening 1051 reserved for supporting a camera or another external device, and microphone array module openings 1052 arranged respectively on both sides of the USB opening 1051. Furthermore a microphone array designed as an array of directional microphones needs to receive sound signals in two directions, so an opening 1053 facing backward can be arranged behind the micro structure 105 to acquire sound from the behind in addition to an opening 1052 facing upward, so that the openings in two directions are designed to thereby make full use of the directivity of the microphones.

It shall be noted that the particular implementations of the display sub-system 12 are also merely exemplary, and in other particular embodiments of the disclosure, the display sub-system 12 can alternatively be embodied otherwise, although a detailed description thereof will be omitted here.

In summary, the multimedia playing device according to the embodiments of the disclosure includes the two components, i.e., the acoustic sub-system including the control unit arranged therein, and the display sub-system, both of which can be upgraded separately, thus reducing the waste of resources, and significantly lowering the cost of the device; and the appearances of the two components can be designed separately so that the display sub-system can be made light-weighted and thin for a pleasing appearance thereof without compromising the size of the speaker in the acoustic sub-system so as to ensure the sound effect of the multimedia playing device, and to greatly satisfy a personalized demand of the user for software applications, a quality of pictures, a quality of sound, and the appearance thereof, thus constantly improving the experience of the user thereof. Moreover the acoustic sub-system and the display sub-system are separate from each other so that it will be more convenient to produce, transport, install, and maintain the multimedia playing device.

The embodiments of the apparatus described above are merely exemplary, where the units described as separate components may or may not be physically separate, and the components illustrated as elements for displaying may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can appreciate that the respective embodiments described above can be performed by software combined with universal hardware platform, of course they can also be performed by hardware. In this case, the technical solution above in nature or a part of the technical solution that contributed to the existing technology can be embodied in the form of a software product, where the software product, including a number of instructions to enable a computor equipment (including a personal computor, a server, or a network equipment, etc.) to perform the methods in the respective embodiments or in a part of the respective embodiments, can be stored in a computer readable storage medium, for example a ROM/RAM, a magnetic disc, an optical disk, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the spirit and scope of the disclosure as claimed.

What is claimed is:

1. A multimedia playing device, comprising an acoustic sub-system and a display sub-system connected with the acoustic sub-system, wherein:
the acoustic sub-system is configured to obtain some image data in a preset format according to one or more external devices' signals, to transmit the image data in the preset format to the display sub-system; and to play an audio according to the one or more external devices' signals; and
the display sub-system is configured to display an image according to the image data in the preset format transmitted by the acoustic sub-system.

2. The multimedia playing device according to claim 1, wherein the acoustic sub-system and the display sub-system are both connected via a control bus.

3. The multimedia playing device according to claim 1, wherein the acoustic sub-system and the display sub-system are connected wirelessly.

4. The multimedia playing device according to claim 1, wherein if the one or more external devices' signals comprise audio data or/and video data, the acoustic sub-system comprises a first signal input unit, a control unit, an output unit, and a speaker unit, wherein:
the first signal input unit is configured to receive the audio data or/and video data;
the control unit is configured to convert the video data into the image data in the preset format, and to process the audio data so that processed audio data can be obtained by the control unit;
the output unit is configured to transmit the image data in the preset format; and
the speaker unit is configured to play audio according to the processed audio data.

5. The multimedia playing device according to claim 1, wherein if the one or more external devices' signals comprise a digital TV signal, the acoustic sub-system comprises a second signal input unit, a digital TV signal processing unit, a control unit, an output unit, and a speaker unit, wherein:
the second signal input unit is configured to receive the digital TV signal;
the digital TV signal processing unit is configured to convert the digital TV signal into audio data or/and video data;
the control unit is configured to convert the video data into the image data in the preset format; and to process the audio data so that processed audio data can be obtained by the control unit;
the output unit is configured to transmit the image data in the preset format; and
the speaker unit is configured to play the processed audio data.

6. The multimedia playing device according to claim 1, wherein the display sub-system comprises a third signal input unit, an image processing unit, and a display unit, wherein:
the third signal input unit is configured to receive the image data in the preset format;
the image processing unit is configured to process the image data in the preset format so that processed image data can be obtained by the image processing unit; and
the display unit is configured to display the processed image data.

7. The multimedia playing device according to claim 6, wherein the third signal input unit is further configured to receive external image data; and
the image processing unit is further configured to process the external image data so that processed external image data can be obtained by the image processing unit.

8. The multimedia playing device according to claim 6, wherein the third signal input unit is further configured to receive and process external voice data.
